(19) United States
(12) Patent Application Publication
(10) Pub. No.: US 2026/0311395 A1
(43) Pub. Date: Oct. 8, 2026

(54) SYSTEM AND METHOD FOR GENERATING GRAPHICAL DESIGN IN A COMPUTER SYSTEM

(71) Applicant: BRILLIANT DESIGN LTD., Kfar Yona (IL)

(72) Inventors: Amichai Mantinband, Kfar Yona (IL); Lior Dagan-Mantinband, Kfar Yona (IL)

(73) Assignee: BRILLIANT DESIGN LTD., Kfar Yona (IL)

(21) Appl. No.: 19/379,886

(22) Filed: Nov. 5, 2025

Related U.S. Application Data
(60) Provisional application No. 63/784,378, filed on Apr. 7, 2025.

(51) Int. Cl. G06T 11/60; G06F 40/58

(52) U.S. Cl. CPC G06T 11/60; G06F 40/58; G06T 2200/24

(57) ABSTRACT

A system and method for generating a graphical design in a computer system includes representing design components of the digital image using mathematical equations, where at least one of the design components is associated with an underlying application, rendering the design components on a transparent canvas presented on the display, and presenting the underlying application on the display through the transparent layer. receive a selection of an operation mode. The system and method may further receive an input event, and direct the input event to the design components of the digital image if a first operation mode was selected and directing the input event to the underlying application if a second operation mode was selected.

### CROSS-REFERENCE TO RELATED APPLICATIONS

This application claims the benefit of U.S. Provisional Application Ser. No. 63/784,378, filed Apr. 7, 2025, which is hereby incorporated by reference in its entirety.

### FIELD OF THE INVENTION

Embodiments of the present invention relate generally to the field of digital graphical design. Some embodiments of the present invention include transparent computerized design environment for contextual digital content creation and manipulation.

### BACKGROUND

A vector graphic design tool is a type of software tool used to create and edit digital images based on mathematical vectors rather than pixels. Unlike raster images, which are made up of tiny squares called pixels, vector graphics use points, lines, curves, and shapes (e.g., polygons) defined by mathematical equations. This allows vector graphics to be scaled to any size without losing quality.

Traditional vector graphic design tools operate in isolated environments that force users to work within a confined canvas separate from any contextual information they may need.

### SUMMARY

According to some embodiments, a computer-based system and method for generating a graphical design in a computer system comprising a processor and a display, the method may include, using the processor: representing design components of the digital image using mathematical equations, wherein at least one of the design components is associated with an underlying application; rendering the design components from the mathematical equations on a transparent canvas presented on the display; and presenting the underlying application on the display through the transparent layer.

Embodiments of the invention may include directing input events to the underlying application through the transparent layer.

Embodiments of the invention may include enabling a user to create, select, and manipulate the design components of the digital image.

Embodiments of the invention may include receiving a selection of an operation mode; receiving an input event; and directing the input event to the design components of the digital image if a first operation mode was selected and directing the input event to the underlying application if a second operation mode was selected.

Embodiments of the invention may include capturing a visual element of the underlying application selected by a user through the transparent canvas; converting the captured visual elements into vector graphics representation; and adding the converted visual elements to at least one of the design components.

According to some embodiments, capturing may be performed by receiving a command in natural language and translating the natural language command into operable commands to select the visual element.

Embodiments of the invention may include adjusting display parameters of at least one of the design components and the underlying application.

Embodiments of the invention may include adjusting a level of opacity of the transparent canvas.

Embodiments of the invention may include presenting toolbar components on the transparent canvas.

Embodiments of the invention may include selectively masking parts of the transparent canvas.

According to some embodiments, a computer-based system and method for generating a graphical design may include: rendering a design component on a transparent canvas presented on a computer display, wherein the design component is rendered from a vector graphics representation of the design component; associating the design component with an underlying application; and presenting the underlying application on the display through the transparent layer.

### BRIEF DESCRIPTION OF THE DRAWINGS

For a better understanding of embodiments of the disclosure and to show how the same can be carried into effect, reference will now be made, purely by way of example, to the accompanying drawings in which like numerals designate corresponding elements or sections throughout.

In the accompanying drawings:

FIG. 1 is a block diagram of an exemplary computing device which may be used with some embodiments.

FIG. 2 is a sample screenshot of a computerized graphical design application, according to some embodiments of the invention.

FIG. 3 is a block diagram of a system for generating a graphical design, according to some embodiments of the invention.

FIG. 4 is a flowchart of a method for generating a graphical design in a computer system comprising a processor and a display, according to embodiments of the invention.

FIG. 5 is a flowchart of a method for snipping content from an underlying application, according to embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the disclosure. However, it will be understood by those skilled in the art that the present disclosure can be practiced without these specific details. In other instances, well-known methods, procedures, and components, modules, units and/or circuits have not been described in detail so as not to obscure the disclosure.

Vector graphic design tools use vector graphics representations to represent design elements. A vector graphics representation may include representing visual images by geometric shapes defined on a Cartesian plane, such as points, lines, curves and polygons. Vector graphics representation of shapes is based on the mathematics of coordinate geometry, in which shapes are defined as a set of points in a two- or three-dimensional cartesian coordinate system using mathematical equations. A vector in vector graphics is an object that has both magnitude (length) and direction. For example, straight lines may be represented by mathematical equations in the form of y=mx+b, where m and b are parameters and x and y or coordinates on the Cartesian coordinates system, circles with radius r may be represented by a mathematical equation in the form of x²+y²=r², and other curves and shapes may be represented by other mathematical equations.

Traditional vector graphic design tools or applications operate in isolated environments referred to as canvas, that are separated from any contextual information they may need, e.g., the design is presented in one window of the computer display, and underlying applications referred to from the design may be presented in different windows. For example, a graphical design may include reference to other applications such as word processors, spreadsheets presentation tools, Internet browsers, image processing applications, etc. and any other software application that may be used to process and present data. However, when a vector graphic design application operates in an isolated environment, the designer cannot access those applications that are referred to from the design. For example, a graphical design may refer to a spreadsheet, however when the designer wants to edit the spreadsheet, the designer cannot access or view the spreadsheet through the vector graphic design application, and needs to open the spreadsheet in a separate application in order to access and view the spreadsheet.

The isolation between the graphical design and the underlying software applications may create several problems or difficulties for the designer. For example, users have to constantly switch between their vector graphic design tool and other applications containing valuable reference material such as documentation, emails, websites, images, similar designs, etc., which may disrupt workflow and cognitive focus of the user. When creating visual content, users may not have direct access to the visual representation of important contextual information that exists in the other applications, leading to designs that may not properly account for the contextual factors. To maintain visual access to reference materials while designing, users often need multiple monitors, one for the design tool and others for reference content, creating hardware requirements and workspace limitations. The isolated environment may make collaboration between designers cumbersome since explaining design concepts while simultaneously referencing relevant materials requires awkward window management or screen sharing setups. Additionally, designers often draw inspiration from existing content, but traditional tools make it difficult to work with that inspiration since the underlying applications are not directly visible.

Embodiments of the invention include a vector graphic design application that includes a transparent interactive display layer or canvas that overlays the underlying applications. This architecture may allow users to design, annotate, and manipulate visual elements in the transparent interactive display layer or canvas while maintaining full visibility of any underlying application or content such as websites, documentation, emails, images, videos, other designs, etc. Additionally, users can interact with this underlying content through a dynamic passthrough mode without closing or hiding their design work. This may transform the creative workflow by eliminating the boundary between design tools and any contextual information users need while creating.

The vector graphic design application according to embodiments of the invention may include transparent canvas architecture. Unlike traditional design tools that operate on an opaque canvas (e.g., an opaque display) in their own window, embodiments of the invention provide a transparent canvas that spans the entire screen or part of the screen, allowing users to see the underlying application or content they choose while creating designs on top of the underlying application. This architecture uses a specialized window management system that maintains the transparent canvas while allowing the transparent canvas to receive and process input events. The transparent canvas, along with other displayed elements, may be a computer-generated construct which may be among a number of items combined on a physical display, such as a monitor 140. As the canvas is transparent, a portion of it may be visible, while other screen objects may be seen even if “under” the canvas.

Embodiments of the invention may employ a dynamic passthrough mechanism that may enable users to temporarily pass through the layer of the transparent canvas to interact with an underlying application without closing or hiding the design environment. This mechanism may work by conditionally redirecting input events (e.g., mouse clicks, keyboard input, etc.) to the underlying application while maintaining the visual overlay of the design elements. The passthrough state can be toggled instantly via customizable keyboard shortcuts or interface controls.

The vector graphic design application may include a comprehensive set of design tools including drawing, shapes, text, image manipulation, etc. that may be specifically engineered to function within the transparent layer. These tools may include specialized rendering techniques that may ensure visibility and usability that is adjusted to the underlying visual content, with automatic contrast adjustments and background handling to maintain design visibility over practically any type of background content. Embodiments may include layering of design elements, within the transparent environment, including z-ordering (e.g., bringing elements forward and backward), grouping and ungrouping, precise positioning, and selection mechanisms optimized for working with elements that may visually overlap with the underlying content.

The vector graphic design application may include a snipping module that may enable capturing elements from an underlying application and importing the captured elements into the design layer, where the captured elements can be manipulated (e.g., resized, repositioned, edited, etc.) within the design environment. The snipping tool may enable direct incorporation of visual elements from any underlying context (e.g., documentation, emails, websites, reference images) into the design process.

Embodiments may include a flexible background control system that may allow users to adjust the visibility of the underlying content through opacity controls of the transparent layer, viewing modes of the transparent layer (e.g., whiteboard and blackboard overlays), and selective masking of portions of the transparent layer, to create optimal design conditions while maintaining visibility of any chosen contextual material. For example, changing the opacity level of the transparent layer may make the undelaying content more visible or less visible, depending on the opacity level, e.g., low opacity levels may make the underlaying content more visible with relation to high opacity levels that may make the underlaying content less visible.

Embodiments may provide cross-platform architecture. The vector graphic design application may be platform-agnostic, allowing the transparent design environment concept to be implemented across various operating systems (e.g., desktop or mobile) regardless of their specific window management systems.

Embodiments of the invention may improve the technology of graphics design, for example by providing a vector graphics design application that enables users to view and manipulate underlying applications, e.g., applications referred to by graphical elements in the design, from within the graphics design tool. This may enable users to maintain visual access to any contextual information they need (documentation, reference images, competitor designs, emails, collaboration messages) while creating, eliminating disruptive context switching. Embodiments may enable quick toggling between different underlying applications to test designs against various contexts without losing design state, and may allow immediate visual comparison between created content and any reference material by having both visible simultaneously.

Users can create cohesive design elements that span multiple applications by seeing them simultaneously, enabling design work that considers the actual relationship between different pieces of content. Embodiments of the invention may simplify graphical design workspace by eliminating the need for multiple monitors or complex window arrangements to maintain access to reference materials during design.

Embodiments of the invention may enhance the users' inspiration flow by allowing users to design directly on top of inspirational content. Embodiments of the invention may enable a more direct translation from inspiration to creation without context breaks.

Unlike traditional design tools with limited reference capabilities, embodiments of this invention allow any application or content to serve as background reference, from emails to spreadsheets to videos to websites.

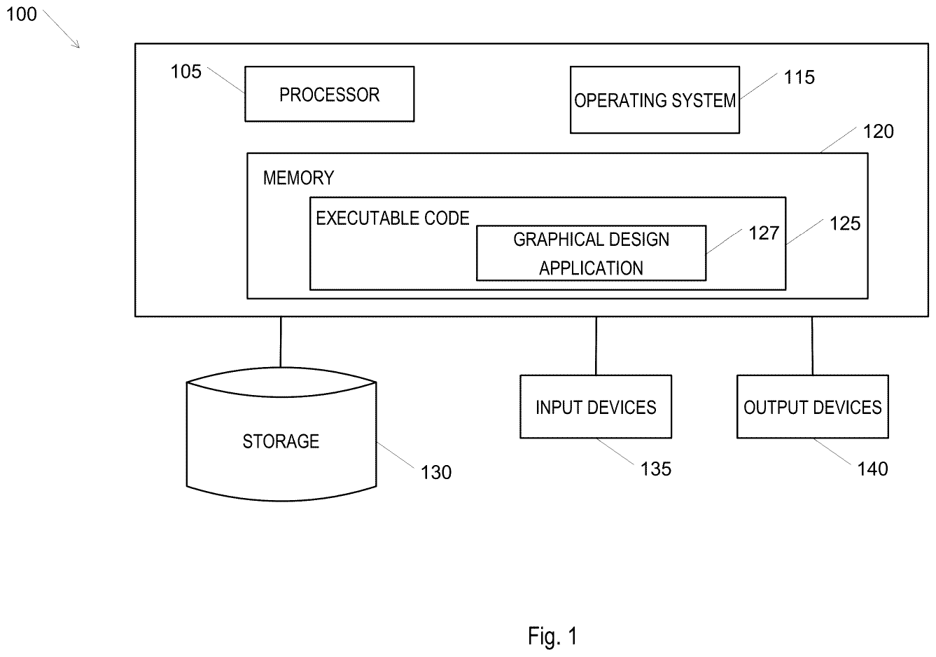

Reference is now made to FIG. 1, which is a block diagram of an exemplary computing device which may be used with some embodiments. Computing device 100 may include a controller or processor 105 that may be or include, for example, logic, one or more central processing unit processor(s) (CPU), one or more graphics processing unit(s) (GPU), one or more data processing unit(s) (DPU), one or more application-specific integrated circuits (ASICs), one or more field programmable arrays (FPGAs), one or more integrated circuits (ICs), a system-on-chip (SoC), a chip or any suitable computing or computational device, an operating system 115, a memory 120, a storage 130, input devices 135 and output devices 140, all connected to each other. Each of modules and equipment such as graphical design application 127, underlying applications 46, and other modules or equipment mentioned herein may be or include, or may be executed by, a computing device such as included in FIG. 1 or specific components of FIG. 1, although various units among these entities may be combined into one computing device. In one embodiment, each of the above-listed modules comprise software that is used to program one or more processors (e.g., processor 105) to perform the functions described herein.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a random access memory (RAM), a read only memory (ROM), a dynamic RAM (DRAM), a synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of possibly different memory units. Memory 120 may store for example, instructions to carry out a method (e.g., executable code 125), and/or data.

Executable code 125 may be any executable code, e.g., software or firmware, an application, a program, a process, task or script (e.g., any of the above-listed modules). Executable code 125 may be executed by processor 105 possibly under control of operating system 115. Executable code 125 may include graphical design application 127, configured to represent design elements of the digital image using mathematical equations, where at least one of the design elements is associated with an underlying application, render or display the design elements on a transparent layer presented on the display, and present or display the underlying application on the display through the transparent layer. Graphical design application 127, may be further configured to receive a selection of an operation mode, receive an input event, direct the input event to the design elements of the digital image if a first operation mode was selected and directing the input event to the underlying application if a second operation mode was selected, and to perform other operations as disclosed herein.

In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments by, for example, executing software or code.

Storage 130 (which is non-transitory) may be or may include, for example, a hard disk drive, a floppy disk drive, a compact Disk (CD) drive, a CD-recordable (CD-R) drive, a universal serial bus (USB) device or other suitable removable and/or fixed storage unit. Data, simulation data, may be stored in a storage 130 and may be loaded from storage 130 into a memory 120 where it may be processed by processor 105. In some embodiments, some of the components shown in FIG. 1 may be omitted. Storage 130 may store data required for performing embodiments of the invention.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more screens, displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card, a modem, printer or facsimile machine, a universal serial bus (USB) device or external hard drive may be included in input devices 135 and/or output devices 140.

Embodiments may include one or more article(s) (e.g., memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

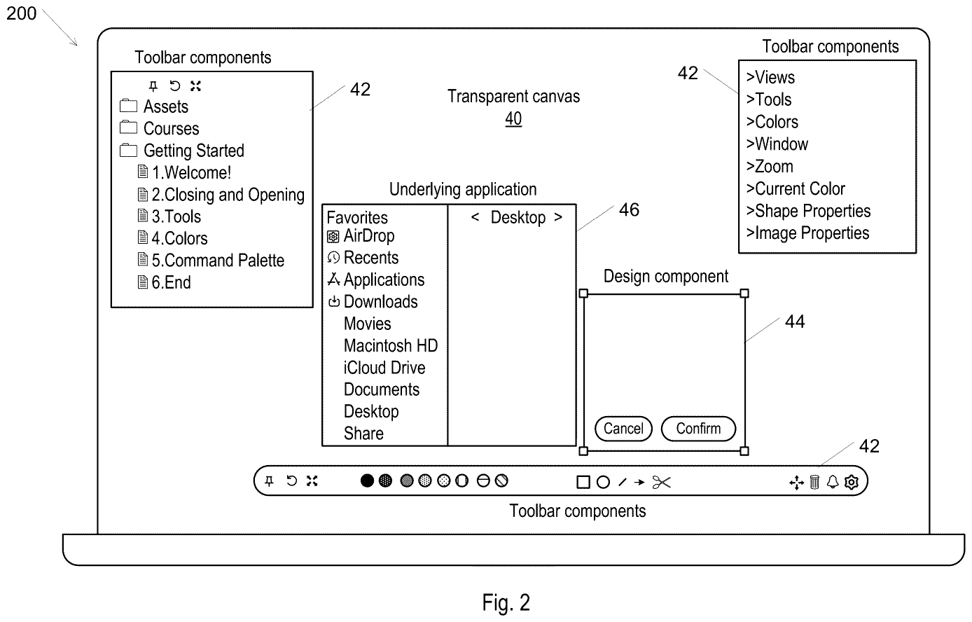

Reference is made to FIG. 2, which is a sample screenshot 200 of a computerized graphical design application 127, according to some embodiments of the invention. Sample screenshot 200 shows the transparent design environment including transparent canvas 40, also referred to herein as a transparent layer, which may span the entire screen or display (e.g., output devices 140) or part of it, toolbar components 42 that can be repositioned or hidden, design components 44 rendered on transparent canvas 40, and the underlying applications 46 visible through transparent canvas 40.

Design components 44 may be a part of a digital design or a digital image presented on a screen or display. Those design components 44 may be represented by processor 105 using vector graphics representation, e.g., by mathematical equations representing design components 44, and may be associated with underlying application 46.

Transparent canvas 40 may maintain transparency at the system level by implementing specialized window properties. As used herein a canvas may refer to the area or window on the display where the digital design is being created and displayed, and transparency may refer to a property of the canvas that enables presenting a design composition 44 associated with an underlying application 46 alongside the underlying application 46 itself, within transparent canvas 40, and controlling both design component 44 and the underlying application 46 through transparent canvas 40.

As can be seen in screenshot 200, design component 44 and underlying application 46 are both visible on transparent canvas 40. In addition, graphical design application 127 may enable a user to design, annotate, and manipulate design component 44, while maintaining full visibility of underlying application 46 or content related to underlying application 46 that the user uses as context or reference. Additionally, graphical design application 127 may enable a user to interact with underlying application 46 through a dynamic passthrough mode without closing or hiding transparent canvas 40. This may transform the creative workflow by eliminating the boundary between graphical design application 127 and any contextual information such as underlying application 46 users need while creating their design.

Manipulation of design component 44 or underlying application 46 may include selection of operation mode and handling of input events. Input events may be directed to design component 44 or to underlying application 46, depending on an operation mode selected by the user. As used herein an operation mode may dictate how input events are being handled by computing system 100. For example, in a first operation mode, referred to herein as a design mode, an input event can be directed to design component 44 and in a second operation mode, referred to herein as a passthrough mode, an input event can be directed to underlying application 46. The user can toggle between the first and second operation modes. Other operation modes may be used.

Underlying applications 46 may include any application executed by computer system 100, such as word processors, spreadsheets presentation tools, Internet browsers, image processing applications, etc. In the finished design, underlying application 46 may be accessible from design component 44, e.g., a user using the finished design, may activate underlying application 46 by taping on design component 44. Embodiments of the invention may enable the designer to access underlying application 46, e.g., activate, control or edit underlying application 46, from within the design environment, e.g., a window showing the presentation of underlying application 46 may be presented on or visible through transparent canvas 40, and the user may provide input to a system to select whether input events will be directed to underlying application 46. If the user selects to direct input events to underlying application 46, the user can provide input (and a system may receive such input) to edit, manipulate and interact with underlying application 46 from within the design environment, through transparent canvas 40.

Handling input events by graphical design application 127 may include focus and activation state management to appropriately handle keyboard input and application switching behaviors, as well as platform-specific permission handling to enable graphical design application 127 to create system-level overlays, capture screen content when needed, and access input events.

When in design mode, graphical design application 127 may enable various graphical design operations such as drawing, adding shapes, adding text, image manipulation, etc. that may function within transparent canvas 40. Graphical design application 127 may further enable creating, editing, and organizing multiple design components 44 within transparent canvas 40, including, for example, z-ordering (e.g., bringing elements forward and/or backward), grouping and/or ungrouping, positioning, and selection mechanisms optimized for working with elements that may visually overlap with underlying content of underlying applications 46.

When in design mode, graphical design application 127 may enable a user to either select an existing element within design component 44 or create a new element to design component 44. Creating a new element may include drawing a selected shape, adding text, drawing a line with endpoints, adding elements snipped from underlying application 46, etc. Graphical design application 127 may enable a user to manipulate the selected or added element. The interaction type may be one of, modifying the style of the element, deleting the element, changing the z-order of the element, e.g., send backward or bring forward, resizing the element, with or without saving the aspect ratio, moving the element, with or without snapping to other elements in design component 44, etc. Once an element is created or manipulated, graphical design application 127 may update the visual rendering of design component 44 on transparent canvas 40.

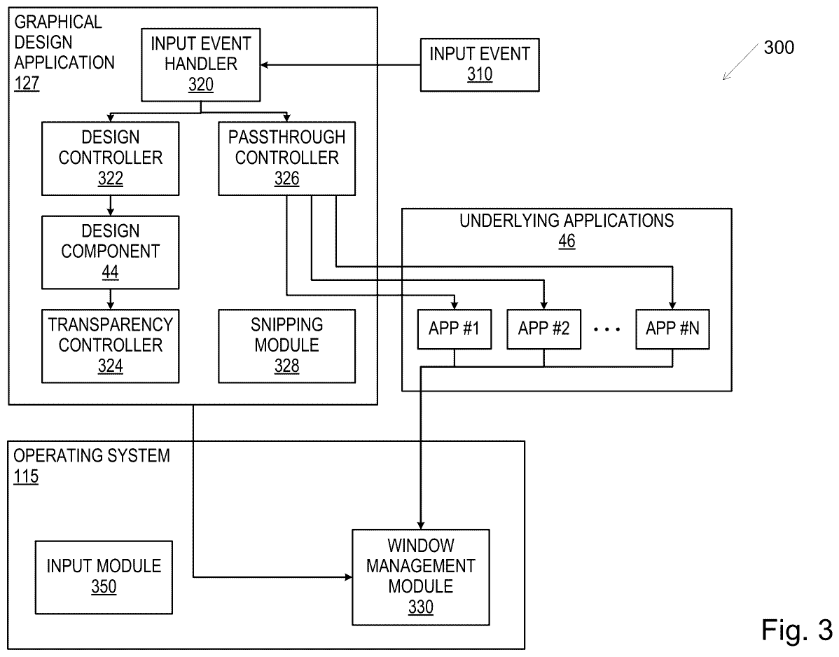

Reference is made to FIG. 3, which is a block diagram of a system 300 for generating a graphical design, according to some embodiments of the invention. It should be understood in advance that the components and functions shown in FIG. 3 are intended to be illustrative only and embodiments of the invention are not limited thereto. While in some embodiments the system of FIG. 3 is implemented using systems as shown in FIG. 1, in other embodiments other systems and equipment can be used.

Graphical design application 127 may be configured to represent design components 44 of the digital image using mathematical equations, associate at least one of design components 44 with underlying application 46, render design components 44 from the mathematical equations representing design components 44, e.g., translate or convert the mathematical equations representing design components 44 into a raster image of design components 44, and present the raster image of design components 44 on the display (output devices 140) on transparent canvas 40, and present the underlying application on the display through the transparent canvas 40. Graphical design application 127 may present toolbar components 42 on transparent canvas 40.

Graphical design application 127 may include input event handler 320, passthrough controller 326 design controller 322, design component 44, transparency controller 324 and snipping module 328. Input event handler 320 may receive input event 310 from a user. Input event 310 may include signals or messages generated by Input module 350 when a user or device provides input to computer system 100, e.g., via any of input devices 135. Input event 310 may be captured by input module 350 in operating system 115 or by an application (e.g., part of executable code 125) and then processed to trigger specific behaviors of computer system 100, as disclosed herein. Input event 310 may include keyboard events such as key press, mouse events such as mouse moves, button press, mouse click and drag, double click, scroll wheel, hover, etc., touchscreen events such as touch start, touch move and touch end, end other events, possibly from other input devices 135. Input events 310 are typically handled by input module 350 in operating system 115, which may place input events 310 into an event queue, and input event handler 320 may react to input events 310 in the event queue.

Input event handler 320 may direct input event 310 to design controller 322 and design component 44 or to underlying applications 46, depending on an operation mode selected by the user. When in design mode, input event handler 320 may direct input event 310 to design controller 322, and when in passthrough mode input event handler 320 may direct input event 310 to underlying applications 46. Design controller 322 may edit or manipulate design component 44 according to the input event 310. Editing or manipulating design component 44 may include, adding or deleting a design element within design component 44, modifying the style of the element, deleting the element, changing the z-order of the element, e.g., send backward or bring forward, resizing the element, with or without saving the aspect ratio, moving the element, with or without snapping to other elements in design component 44, etc. Design controller 322 may represent design component 44 design using mathematical equations. When in passthrough mode input event handler 320 may direct input event 310 to any one of a plurality of underlying applications 46, e.g., APP #1, APP #2, etc., and enable the user to edit and manipulate content in underlying applications 46 from within graphical design application 127.

Graphical design application 127 may include a transparency controller 324 configured to apply rendering techniques that may translate the mathematical equations representing design component 44 into raster images that are made up of pixels. The rendering techniques applied by transparency controller 324 may enable visibility and usability of design component 44 regardless of the underlying visual content of underlying applications 46, with automatic contrast adjustments and background handling to maintain visibility of design component 44 over any type of background content.

Transparency controller 324 may be configured to adjust display parameters of transparent canvas 40, design components 44 and underlying application 46, to enable visibility of the design components 44 and the underlying application 46. The display parameters may be adjusted automatically to provide optimal or preconfigured contrast and visibility, or manually by the user using associated commands that may enable users to adjust the transparency of transparent canvas 40, and the visibility of design components 44 and underlying application 46. Transparency controller 324 may adjust display parameters by adjusting or configuring view parameters of transparent canvas 40 and/or display attributes of operating system 115, e.g., parameters of window management module 330. The adjustable display parameters may include opacity controls, specialized viewing modes (e.g., whiteboard and blackboard overlays), selective masking to create optimal design conditions while maintaining visibility of the underlying content, etc. The opacity controls may enable adjusting a level of opacity of the transparent layer (automatically or manually), e.g., by configuring opacity level of transparent canvas 40 and/or display attributes of an operating system 115. Transparency controller 324 may adjust display parameters to selectively mask parts of transparent canvas 40, e.g., according to a mask received from a user.

Graphical design application 127 may include snipping module 328 that may enable snipping of underlying content, e.g., capturing visual elements from underlying application 46, converting or translating the captured visual elements into vector graphics representation, e.g., into mathematical equations that represent the captured visual elements, and adding the converted visual elements to design component 44 (existing or newly created). The added elements can then be edited and manipulated (e.g., resized, repositioned, changed, etc.) within transparent canvas 40 like any other design elements in design component 44. This may enable the incorporation of visual elements from underlying application 46 (e.g., documentation, emails, websites, reference images, etc.) into design components 44. Snipping module 328 may enable the user to capture or select content from underlying application 46 based on instructions received from a user in the form of one or more input events. Snipping module 328 may enable the user to select content from underlying application 46 using any desirable input device 135 and selection mode, e.g., rectangular, window, free form, etc., using, for example, mouse click and drag, or touch move to highlight the area the user wants to capture. In some embodiments, snipping module 328 may enable the user to capture or select content from underlying application 46 using natural language in voice or text, e.g., the user may say or type commands such as “snip the hero of the website” or “turn the hero section of the website into editable vectors”. Voice commands may be translated into text using speech to text applications, and a large language model (LLM) may translate the natural language into operable commands to graphical design application 127.

Window management module 330 may be a part of operating system 115 that manages windows of applications executed by processor 105, each application may have none to any number of windows. Window management module 330 manages a z-index based hierarchy of windows, controlling which window will be on top of which, alongside the dimensions and location of the window. According to some embodiments, graphical design application 127 may configure transparent canvas 40 to have a high z-index and thus be displayed on top of windows of other applications, such as underlying application 46. As noted elsewhere, underlying application 46 may be visible through transparent canvas 40.

Graphical design application 127 may be implemented across various types of operating systems 115. For each operating system 115, implementing transparent canvas 40 may include multi-display support through screen detection and window repositioning to maintain proper coverage across various display configurations and coordinate system transformation management to accurately map between screen coordinates, window coordinates, application-specific coordinate systems and accounting for scaling factors, orientation, and resolution differences. In addition, graphics compositing optimizations (e.g., optimizing the way design elements are rendered for example as vectors or as a rasterized image) to maintain performance while rendering transparent content (e.g., design component 44) may include hardware acceleration through platform-specific graphics application programming interfaces (APIs), selective rendering of modified regions, and buffering strategies to reduce flickering and artifacts.

Graphical design application 127 may be implemented on a variety of operating systems 115, taking advantage of specific capabilities of the operating system 115. Implementations on popular operating systems 115 are provided in Table 1. The technical approaches provided in Table 1 represent several example methods of implementing graphical design application 127 and transparent canvas 40, however, embodiments are not limited to these specific implementations. Alternative approaches that achieve similar functional result of implementing graphical design application 127 and transparent canvas 40 above underlying applications 46 while maintaining visibility and selective interaction with design components 44 and underlying applications 46 may be applied.

TABLE 1
Implementing graphical design application and transparent canvas
above underlying applications on popular operating systems:

| Operating | |
|---|---|
| System | Procedure |
| Windows | 1. Creating a layered window with the WS_EX_LAYERED and |
| | WS_EX_TRANSPARENT extended window styles. |
| | 2. Setting window attributes including: |
| | FormBorderStyle set to None to remove standard window decorations. |
| | BackColor configured with transparency value. |
| | TopMost property set to True to maintain position above other |
| | applications. |
| | 3. Utilizing the Windows Desktop Window Manager (DWM) API to: |
| | Enable per-pixel alpha blending through |
| | DwmExtendFrameIntoClientArea. |
| | Configure window transparency with appropriate MARGINS |
| | structure. |
| | Implement window compositing for smooth rendering. |
| | 4. Managing the window's region through the SetWindowRgn API to define |
| | the interactive area while maintaining transparency. |
| | 5. Implementing a window procedure (WndProc) that selectively processes |
| | or redirects input events to underlying applications based on the current |
| | operational mode. |
| macOS | 1. Creating a borderless window with specific properties: styleMask: |
| | [.borderless, .fullSizeContentView], backing: .buffered |
| | Configuring essential window attributes: |
| | Setting window level to .floating to position it above other applications |
| | Setting backgroundColor to .clear and isOpaque to false for |
| | transparency |
| | Configuring contentView.wantsLayer to false for proper compositing |
| | Setting hasShadow to false to eliminate window shadows |
| | Setting titleVisibility to .hidden and titlebarAppearsTransparent to true |
| | 2. Implementing special window behavior properties: |
| | collectionBehavior: [.canJoinAllSpaces, .fullScreenAuxiliary] to make |
| | the window available across all desktop spaces and in full-screen |
| | applications. |
| | acceptsMouseMovedEvents configured based on operational mode. |
| | 3. Utilizing specialized NSWindow subclassing to override: |
| | canBecomeKey and canBecomeMain properties to ensure proper |
| | keyboard focus handling. |
| | hitTest methods to implement conditional event handling. |
| | 4. Managing event responder chains to selectively process or redirect input |
| | events based on the current operational mode. |
| Linux (X11 | 1. For X11: |
| or Wayland | Creating a window with override_redirect attribute set to True to |
| protocols) | bypass window manager decorations. |
| | Setting _NET_WM_WINDOW_TYPE to an appropriate atom type |
| | such as _NET_WM_WINDOW_TYPE_DOCK. |
| | Configuring _NET_WM_WINDOW_OPACITY for translucency |
| | Utilizing the Shape extension (XShape) to define input regions. |
| | 2. For Wayland: |
| | Implementing support for the xdg-shell protocol with the layer-shell |
| | extension. |
| | Creating a surface at the |
| | ZWLR_LAYER_SHELL_V1_LAYER_OVERLAY level. |
| | Configuring surface properties for transparency and proper |
| | positioning. |
| | Implementing selective keyboard interactivity. |
| | 3. Handling compositing through appropriate visual formats with 32-bit color |
| | depth (including alpha channel) support. |
| | 4. Implementing appropriate event handlers that maintain visual presence |
| | while conditionally redirecting input to underlying windows. |
| iOS | 1. Creating a UIWindow subclass with: |
| | windowLevel set to UIWindow.Level.statusBar - 1 or an appropriate |
| | level. |
| | isOpaque property set to false. |
| | backgroundColor set to UIColor.clear. |
| | 2. Implementing a custom UIViewController structure for the window that |
| | provides appropriate view hierarchies for both transparent regions and |
| | interactive elements. |
| | 3. Overriding the hitTest:withEvent: method to selectively process touch |
| | events based on: |
| | Current operational mode. |
| | Presence of interactive elements at the touch location. |
| | Desired behavior for the specific region. |
| | 4. Utilizing CALayer properties to manage rendering and compositing of the |
| | transparent layer with underlying content. |
| Android | 1. Creating an overlay service using: |
| | WindowManager.LayoutParams.TYPE_APPLICATION_OVERLAY |
| | window type |
| | PixelFormat.TRANSLUCENT pixel format |
| | Appropriate layout flags such as FLAG_NOT_FOCUSABLE and |
| | FLAG_LAYOUT_IN_SCREEN |
| | 2. Configuring window parameters: |
| | Setting layout dimensions to MATCH_PARENT for full-screen |
| | coverage |
| | Adding FLAG_LAYOUT_NO_LIMITS to allow extending beyond |
| | screen boundaries if needed |
| | Implementing transparency through background attributes |
| | 3. Implementing selective touch handling through: |
| | Conditional use of FLAG_NOT_TOUCHABLE flag |
| | Custom touch listeners that can analyze and selectively consume or |
| | pass through events |
| | View.onTouchEvent overrides with appropriate return values |
| | 4. Managing focus and input method interactions to maintain proper keyboard |
| | input handling. |

While graphical design application 127 may be specific to each operating system 115, the design may be platform-agnostic, e.g., may be the same for all supported operating systems, allowing the design to be edited and manipulated across various operating systems 115 (desktop or mobile) regardless of their specific window management systems.

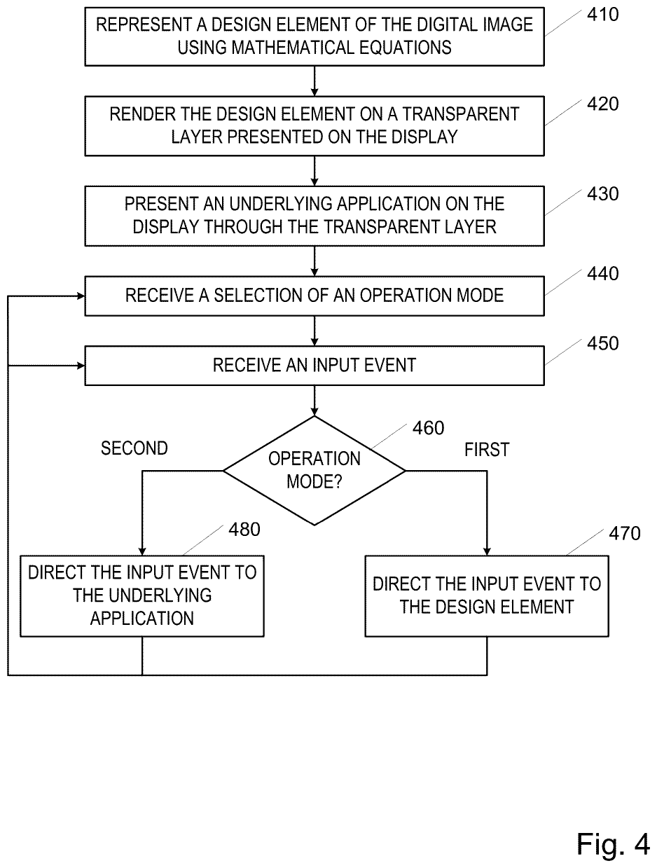

Reference is now made to FIG. 4, which is a flowchart of a method for generating a graphical design in a computer system comprising a processor and a display, according to embodiments of the invention. While in some embodiments the operations of FIG. 4 are carried out using systems as shown in FIGS. 1 and 3, in other embodiments other systems and equipment can be used. Operations 410-440 may be performed in other order, or in parallel to each other.

In operation 410, a processor (e.g., processor 105 depicted in FIG. 1 executing code to carry out the method for generating a graphical design according to embodiments of the present invention) may represent design components (such as design component 44) of a digital image or a digital design using mathematical equations. The design components of the digital design may be generated by a user on a transparent canvas (such as transparent canvas 40). In some embodiments, at least one of the design elements may be associated with an underlying application, e.g., in the finished design, the design components may include controls configured to activate or interact with the underlying application. For example, an icon on the finished design may open a spreadsheet, executed by a spreadsheet editor, or a website executed by an Internet browser, or any other application.

In operation 420, the processor may render the design components on a transparent canvas presented on the display or screen of a computer (e.g., on output devices 140 of computing device 100), so that the design component may be visible on the computer display or screen. Rendering the design component on a transparent canvas may include translating the mathematical equations representing the design element into raster images that are made up of pixels. The transparent canvas may include the entire display area and maintain transparency at the system level by implementing specialized window properties that differ across platforms. In operation 430, the processor may present the underlying application, e.g., a graphic representation of the underlying application, on the display or screen through the transparent canvas. Thus, the design element and the associated underlying application may be both presented and visible on the transparent canvas.

In operation 440, the processor may receive a selection of an operation mode, e.g., a selection made by a user of how input events should be handled by the processor. In operation 450, the processor may receive an input event. As indicated by operation 460, in a first operation mode (design mode), the input event is directed to the design element, as indicated by operation 470, and in a second operation mode (passthrough mode), the input event is directed to the underlying application, as indicated by operation 480. Embodiments of the method may return to operation 440 if a new selection of an operation mode is received, and to operation 450 if a new input event is received.

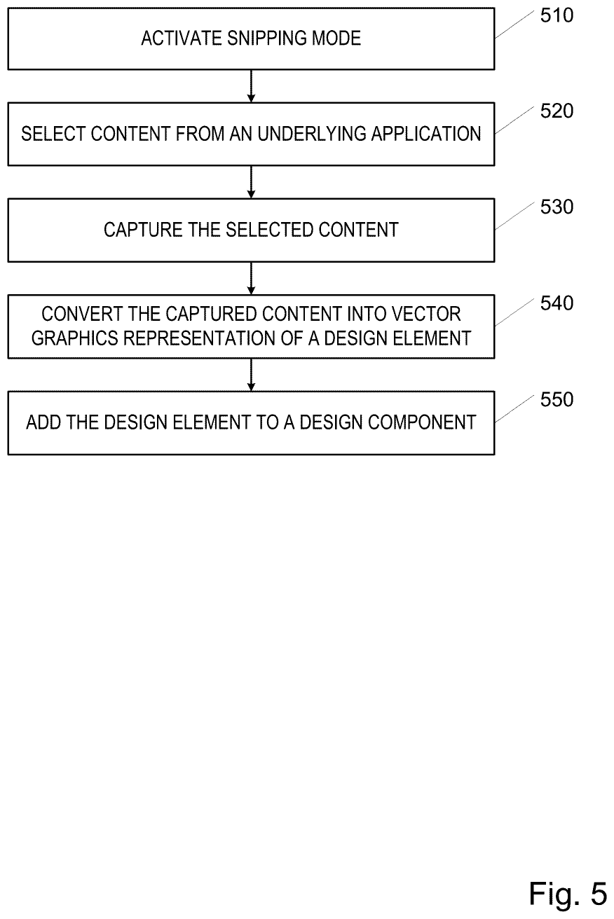

Reference is now made to FIG. 5, which is a flowchart of a method for snipping content from an underlying application, according to embodiments of the invention. While in some embodiments the operations of FIG. 5 are carried out using systems as shown in FIGS. 1 and 3, in other embodiments other systems and equipment can be used.

In operation 510, a processor (e.g., processor 105 depicted in FIG. 1 executing code to carry out the method for generating a graphical design according to embodiments of the present invention) may activate snipping mode. In operation 520, the processor may select content from an underlying application such as underlying application 46. The processor may select content from an underlying application based on instructions received from a user in the form of one or more input events. Content may be selected by the user using any desirable selection mode, e.g., rectangular, window, free form, etc., using, for example, mouse click and drag, or touch move to highlight the area the user wants to capture. In some embodiments, content may be captured or selected by the user using natural language in voice or text, e.g., the user may say or type commands such as “snip the hero of the website” or “turn the hero section of the website into editable vectors”. Voice commands may be translated into text using speech to text applications, and a large language model (LLM) may translate the natural language into operable commands to graphical design application 127.

In operation 530, the processor may capture the selected content. In operation 540, the processor may convert or translate the captured content into vector graphics representation, e.g., generate one or more new design elements from the captured content that are represented by mathematical equations. In operation 550, the processor may add the new design element to a design component such as design component 44, and present the new design element as part of the design component on the transparent canvas (e.g., transparent canvas 40).

One skilled in the art will realize the embodiments may be embodied in other specific forms without departing from the spirit or essential characteristics thereof. The foregoing embodiments are therefore to be considered in all respects illustrative rather than limiting of the embodiments described herein. Scope of the embodiments is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the embodiments. However, it will be understood by those skilled in the art that the embodiments can be practiced without these specific details. In other instances, well-known methods, procedures, and components, modules, units and/or circuits have not been described in detail so as not to obscure the embodiments. Some features or elements described with respect to one embodiment can be combined with features or elements described with respect to other embodiments.

Although embodiments of the embodiments are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the embodiments are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method for generating a graphical design in a computer system comprising a processor and a display, the method comprising, using the processor:
representing design components of a digital image using mathematical equations, wherein each of a portion of the design components is associated with one of a plurality of underlying applications, wherein each of the plurality of underlying applications is presented in a window managed by an operating system of the computer system;
rendering the design components from the mathematical equations on a transparent canvas presented on the display, wherein the transparent canvas comprises a window operated by the operating system of the computer system; and
presenting the windows of the plurality of underlying applications on the display through the window of the transparent canvas.

2. The method of claim 1, comprising:
directing input events to one of the plurality of underlying applications through the transparent canvas.

3. The method of claim 1, comprising:
enabling a user to create, select, and manipulate the design components of the digital image.

4. The method of claim 1, comprising:
receiving a selection of an operation mode;
receiving an input event; and
directing the input event to the design components of the digital image if a first operation mode was selected and directing the input event to one of the plurality of underlying applications the if a second operation mode was selected.

5. The method of claim 1, comprising:
capturing a visual element of one of the plurality of underlying applications selected by a user through the transparent canvas;
converting the captured visual elements into vector graphics representation; and
adding the converted visual elements to at least one of the design components.

6. The method of claim 5, wherein capturing is performed by:
receiving a command in natural language; and
translating the natural language command into operable commands to select the visual element.

7. The method of claim 1, comprising adjusting display parameters of at least one of the design components and one of the plurality of underlying applications.

8. The method of claim 1, comprising adjusting a level of opacity of the transparent canvas.

9. The method of claim 1, comprising presenting toolbar components on the transparent canvas.

10. The method of claim 1, comprising selectively masking parts of the transparent canvas.

11. A device for generating a graphical design comprising:
a memory;
a display; and
a processor configured to:
represent design components of a digital image using mathematical equations, wherein each of a portion of the design components is associated with one of a plurality of underlying applications, wherein each of the plurality of underlying applications is presented in a window managed by an operating system of the computer system;
render the design components from the mathematical equations on a transparent canvas presented on the display, wherein the transparent canvas comprises a window operated by the operating system of the computer system; and
present the windows of the plurality of underlying applications on the display through the window of the transparent canvas.

12. The device of claim 11, wherein the processor is configured to:
direct input events to one of the plurality of underlying applications through the transparent canvas.

13. The device of claim 11, wherein the processor is configured to:
receive commands from a user to create, select, and manipulate the design components of the digital image.

14. The device of claim 11, wherein the processor is configured to:
receive a selection of an operation mode;
receive an input event; and
direct the input event to the design components of the digital image if a first operation mode was selected and directing the input event to one of the plurality of underlying applications if a second operation mode was selected.

15. The device of claim 11, wherein the processor is configured to:
capture a visual element of one of the plurality of underlying applications selected by a user through the transparent canvas;
convert the captured visual elements into vector graphics representation; and
add the converted visual elements to at least one of the design components.

16. The device of claim 11, wherein the processor is configured to capture the visual element by:
receive a command in natural language; and
translate the natural language command into operable commands to select the visual element.

17. The device of claim 11, wherein the processor is configured to adjust display parameters of at least one of the design components and one of the plurality of underlying applications.

18. The device of claim 11, wherein the processor is configured to adjust a level of opacity of the transparent canvas.

19. The device of claim 11, wherein the processor is configured to selectively mask parts of the transparent canvas.

20. A computer-based method for generating a graphical design, the method comprising:
rendering a design component on a transparent canvas presented on a computer display, wherein the transparent canvas comprises a window operated by the operating system of the computer system, and wherein the design component is rendered from a vector graphics representation of the design component;
associating the design component with an underlying application, wherein the underlying application is any application presented in a window managed by an operating system of the computer system; and
presenting the underlying application on the display through the window of the transparent canvas.

21. The method of claim 1, wherein at least one of the design components is associated with an underlying application in a manner that in a finished design, the underlying application is activated through the design component.
